(19) United States
(12) Patent Application Publication
(10) Pub. No.: US 2016/0291409 A1
(43) Pub. Date: Oct. 6, 2016

(54) LIQUID CRYSTAL DISPLAY INCLUDING PIXEL AND AUXILIARY ELECTRODES WITHIN DISPLAY SUBSTRATE

(71) Applicant: Samsung Display Co., Ltd., Yongin-Si (KR)

(72) Inventors: Dong-Chul SHIN, Seoul (KR); Su Jin KIM, Seoul (KR); Jin Won KIM, Suwon-si (KR); Ki Chul SHIN, Seongnam-si (KR); Hyeok Jin LEE, Seongnam-si (KR)

(21) Appl. No.: 14/921,007

(22) Filed: Oct. 23, 2015

(30) Foreign Application Priority Data
Apr. 1, 2015 (KR) 10-2015-0046219

(51) Int. Cl. G02F 1/1337; G02F 1/1333; G02F 1/1343

(52) U.S. Cl. CPC G02F 1/133707; G02F 1/134309; G02F 1/133345; G02F 1/13439

(57) ABSTRACT

A liquid crystal display includes: a lower display substrate; an upper display substrate facing the lower display substrate; and a liquid crystal layer disposed between the lower display substrate and the upper display substrate and including liquid crystal molecules. The lower display substrate includes a pixel electrode disposed on a first base substrate; and a cross-shaped auxiliary electrode disposed overlapping the pixel electrode on the first base substrate. The upper display substrate includes a common electrode disposed on a second base substrate.

This application claims priority to Korean Patent Application No. 10-2015-0046219 filed on Apr. 1, 2015, and all the benefits accruing therefrom under 35 U.S.C. §119, the entire contents of which are incorporated herein by reference.

### BACKGROUND

(a) Field

The invention relates to a liquid crystal display.

(b) Description of the Related Art

A liquid crystal display (“LCD”), which is one of the most widely used flat panel displays, includes two sheets of display substrates with field generating electrodes therein and a liquid crystal layer interposed between the two display substrates. The LCD displays an image by applying voltages to the field generating electrodes to generate an electric field in the liquid crystal layer, determining alignment directions of liquid crystal molecules of the liquid crystal layer through the generated field, and controlling polarization of incident light. Among LCDs, there is a vertical alignment (“VA”) mode LCD in which long axes of liquid crystal molecules are perpendicular with respect to the display substrates when no electric field is applied. Securing a relatively wide viewing angle in the VA mode LCD is regarded as being critical. In order to secure the wide viewing angle, a technique for creating a plurality of domains in which tilt directions of liquid crystal molecules are differently controlled by forming slits or protrusions in field generating electrodes has been used.

### SUMMARY

One or more exemplary embodiment of the invention provides a liquid crystal display (“LCD”) with improved side visibility and improved transmittance thereof.

In addition, one or more exemplary embodiment of the invention provides an LCD which reduces display quality deterioration that can occur when a lower display substrate and an upper display substrate thereof are misaligned.

A LCD according to an exemplary embodiment of the invention includes: a lower display substrate including: a pixel electrode disposed on a first base substrate; and a cross-shaped auxiliary electrode disposed overlapping the pixel electrode on the first base substrate; an upper display substrate facing the lower display substrate the upper display substrate including a common electrode disposed on a second base substrate; and a liquid crystal layer disposed between the lower display substrate and the upper display substrate and including liquid crystal molecules.

The lower display substrate may further include an insulating layer disposed between the cross-shaped auxiliary electrode disposed overlapping the pixel electrode and the pixel electrode which is overlapped thereby. The pixel electrode and the auxiliary electrode between which is disposed the insulating layer receive may receive a same voltage.

The insulating layer disposed between the pixel electrode and the auxiliary electrode may include silicon nitride and may have a thickness of about 3,000 angstroms (Å) to about 5,000 Å.

Among the cross-shaped auxiliary electrode disposed overlapping the pixel electrode and the pixel electrode which is overlapped thereby, a slit may be defined in the pixel electrode at outer edges of the pixel electrode.

In a top plan view, pretilt direction of each of the liquid crystal molecules may be arranged extended toward a center portion of the auxiliary electrode from respective points where the outer edges of the pixel electrode meet each other.

The pixel electrode may be divided into a plurality of domains by the outer edges of the pixel electrode and the auxiliary electrode which overlaps the pixel electrode, and among the plurality of domains, the pretilt directions of the liquid crystal molecules may be different from each other.

In a state where no electric field is applied to the liquid crystal layer, long axes of the liquid crystal molecules may be arranged substantially perpendicular to surfaces of the first and second display substrates.

In a top plan view, the auxiliary electrode may or may not overlap the slit defined in the pixel electrode at the outer edges of the pixel electrode.

In a top plan view, a width of the auxiliary electrode at a distal end thereof may be smaller than that at a center thereof.

The common electrode may have a plate shape.

Among the cross-shaped auxiliary electrode disposed overlapping the pixel electrode and the pixel electrode which is overlapped thereby, a ratio of an effective voltage of the pixel electrode to that of the auxiliary electrode may be between about 0.85 and about 0.9.

The pixel electrode and the auxiliary electrode within the first display substrate and between which the insulating layer is disposed may be electrically connected to each other.

The pixel electrode and the auxiliary electrode within the first display substrate and between which the insulating layer is disposed may receive different voltages from each other.

One or more exemplary embodiment of the LCD according to the invention suppresses the generation of texture while making the side visibility thereof as close to the front visibility thereof without deteriorating the transmittance thereof. In addition, since slits defined in the common electrode to improve control of the liquid crystal molecules are omitted, transmittance deterioration or texture generation due to the misalignment between the slits and pixel electrodes can be reduced or effectively prevented and the additional process for forming the slits in the common electrode can be omitted to reduce manufacturing time and costs.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 is a top plan view of an exemplary embodiment of a liquid crystal display (“LCD”) according to the invention.

FIG. 2 is a cross-sectional view of the LCD of FIG. 1 taken along line II-II.

FIG. 3 is a top plan view of an exemplary embodiment of a basic region of a field generating electrode illustrated in FIG. 1.

FIG. 4 is a cross-sectional view of the field generating electrode of FIG. 3 taken along line IV-IV.

FIGS. 5 and 6 are top plan views respectively showing other exemplary embodiments of basic regions of a field generating electrodes according to the invention.

FIG. 7 is a graph showing variation of an effective voltage in volts (V) with respect to a thickness in micrometers (μm) and material of an insulating layer.

FIG. 8 illustrates an exemplary embodiment of a process in which liquid crystal molecules are formed to have a pretilt.

FIG. 9 (a) and FIG. 9(b) schematically illustrate directions of liquid crystals in exemplary embodiments of the basic region of the field generating electrode according to the invention.

FIG. 10 include views of simulation results showing texture control in an exemplary embodiment of an LCD according to the invention and texture control in a comparative example of an LCD.

FIG. 11 is a graph showing transmittance of the exemplary embodiment of the LCD according to the invention and transmittance of the comparative example of the LCD.

FIG. 12 is a graph showing variation of transmittance the exemplary embodiment of the LCD according to the invention and the comparative example of the LCD with respect to gray.

### DETAILED DESCRIPTION

The invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the invention. In the drawings, the thickness of layers, films, panels, regions, etc. are enlarged or exaggerated for clarity.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Examples of techniques for creating a plurality of domains in a flat panel display device include defining a plurality of minute slits in a pixel electrode, defining slits in a common electrode instead of defining minute slits in a pixel electrode, and defining protrusions relative to a pixel electrode. The technique which defines a plurality of minute slits in a pixel electrode has a problem in that transmittance of the flat panel display device decreases. In the technique which defines slits in a common electrode, transmittance decreases when misalignment between the pixel electrode and the common electrode occurs, and such misalignment may be more problematic in a curved flat panel display as compared to a non-curved flat panel display. In the technique which defines protrusions relative to a pixel electrode, light leakage is generated and defining a protrusion of a desired shape is difficult. Therefore, there remains a need for an improved technique for creating a plurality of domains to achieve a relatively wide viewing angle of a flat panel display device without decreasing transmittance of the flat panel display device.

A liquid crystal display (“LCD”) according to an exemplary embodiment of the invention will now be described in detail with reference to the drawings.

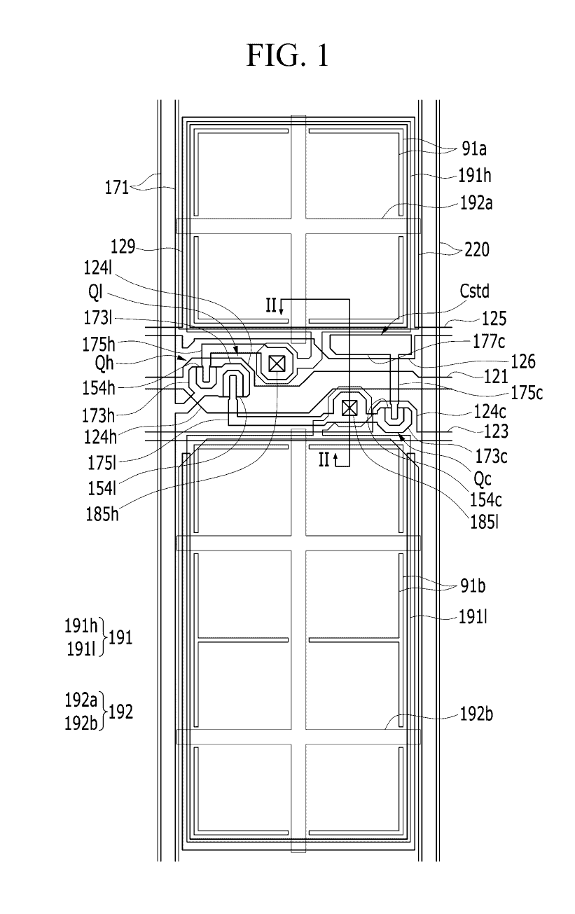

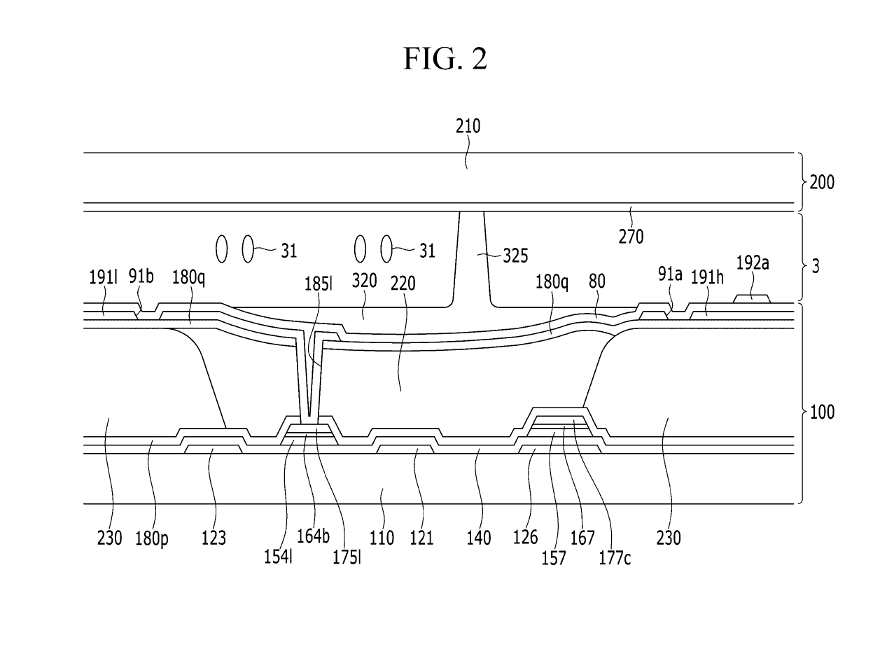

FIG. 1 is a top plan view of an exemplary embodiment of an LCD according to the invention, and FIG. 2 is a cross-sectional view of the LCD of FIG. 1 taken along line II-II.

Referring to FIGS. 1 and 2, the LCD includes: lower and upper display substrates 100 and 200 facing each other; a liquid crystal layer 3 interposed between the two display substrates 100 and 200; and a pair of polarizers (not shown) attached to outer surfaces of the display substrates 100 and 200. A plurality of pixels arranged substantially in a matrix shape is defined on the lower display substrate 100. A pixel may be defined as an independent area unit capable of independently controlling the liquid crystal, but the invention is not limited thereto. A pixel area may be defined within a pixel.

First, the lower display substrate 100 will be described.

Gate conductors including a gate line 121, a step-down gate line 123 and a storage electrode line 125 are disposed on a first insulation substrate 110 as a base substrate of the lower display substrate 100.

The gate line 121 and the step-down gate line 123 have a length which mainly extends in a horizontal direction in the top plan view, to transmit a gate signal. The gate line 121 includes extended from a main portion thereof first and second gate electrodes 124h and 124l that protrude upward and downward in a vertical direction of the top plan view, and the step-down gate line 123 includes extended from a main portion thereof a third gate electrode 124c that protrudes upward in the vertical direction of the top plan view. The first and second gate electrodes 124h and 124l are connected to each other to form one unitary protruding portion.

The storage electrode line 125 has a length which mainly extends in the horizontal direction and transmits a predetermined voltage, such as a common voltage. The storage electrode line 125 includes a storage electrode 129 that extends along at least one edge of first and second subpixel electrodes 191h and 191l, and a capacitive electrode 126 that is extended downward in the vertical direction from the storage line 125.

A gate insulating layer 140 is disposed on the gate conductors 121, 123 and 125.

Semiconductors 154h, 154l, 154c and 157, which may include or be made of amorphous silicon or crystalline silicon, are disposed on the gate insulating layer 140. Among the aforementioned semiconductors, first and second semiconductors 154h and 154l are extended along the first and second gate electrodes 124h and 124l, and are connected to each other. A third semiconductor 154c is connected to the second semiconductor 154l, and an extended portion thereof defines a fourth semiconductor 157. The semiconductors 154h, 154l, 154c and 157 may collectively form a unitary semiconductor member.

A plurality of ohmic contacts are disposed on the semiconductors 154h, 154l, 154c and 157. A first ohmic contact (not shown) is disposed on the first semiconductor 154h. A second ohmic contact 164b and a third ohmic contact (not shown) are respectively disposed on the second semiconductor 154l and the third semiconductor 154c. The third ohmic contact is extended to define a fourth ohmic contact 167. If the aforementioned semiconductors are oxide semiconductors, the ohmic contacts described above may be omitted.

Data conductors including a data line 171, a first drain electrode 175h, a second drain electrode 175l and a third drain electrode 175c are disposed on the ohmic contacts such as including first and fourth 164b and 167.

The data line 171 transmits a data signal, and has a length which mainly extends in the vertical direction to cross the gate line 121 and the step-down gate line 123. The data line 171 includes extended from a main portion thereof first and second source electrodes 173h and 173l connected to each other to form a unitary source electrode member. The first and second source electrodes 173h and 173l respectively extend toward the first and second gate electrodes 124h and 124l from the main portion of the data line 171.

The first, second and third drain electrodes 175h, 175l and 175c include a wide first end portion and a rod-shaped second end portion opposite thereto. The rod-shaped second end portions of the first and second drain electrodes 175h and 175l are partially enclosed by the first and second source electrodes 173h and 173l, respectively. The wide first end portion of the second drain electrode 175l is extended to define the third source electrode 173c that is bent in a U-shape in the top plan view. An expansion 177c as a wide first end portion of the third drain electrode 175c overlaps the capacitive electrode 126 to form a step-down capacitor Cstd, and the rod-shaped second end portion thereof is partially enclosed by the third source electrode 173c.

The first gate electrode 124h, the first source electrode 173h and the first drain electrode 175h form a first thin film transistor Qh in conjunction with the first semiconductor 154h, and a channel of the first thin film transistor Qh is defined in a portion of the first semiconductor 154h exposed between the source electrode 173h and the drain electrode 175h. Similarly, the second gate electrode 124l, the second source electrode 173l and the second drain electrode 175l form a second thin film transistor Ql, and a channel of the second thin film transistor Ql is defined in a portion of the second semiconductor 154l exposed between the second source electrode 173l and the second drain electrode 175l. The third gate electrode 124c, the third source electrode 173c and the third drain electrode 175c form a third thin film transistor Qc in conjunction with the third semiconductor 154c, and a channel of the third thin film transistor Qc is defined in a portion of the third semiconductor 154c exposed between the third source electrode 173c and the third drain electrode 175c.

The semiconductors 154h, 154l and 154c may have substantially the same planar shape as the data conductors 171, 175h, 175l and 175c and the ohmic contacts 164l and 167 therebelow, except at channel regions respectively defined between the source electrodes 173h, 173l and 173c and the drain electrodes 175h, 175l, and 175c. That is, portions of the semiconductors 154h, 154l, and 154c are not covered (e.g., exposed) by the data conductors 171, 175h, 175l, and 175c, as well as portions thereof between the source electrodes 173h, 173l, and 173c and the drain electrodes 175h, 175l, and 175c are not covered so as to be exposed.

A first passivation layer 180p including or made of an inorganic insulating material such as silicon nitride (SiNₓ) or silicon oxide (SiOₓ) is disposed on the data conductors 171, 175h, 175l and 175c and on exposed portions of the semiconductors 154h, 154l, and 154c.

A color filter 230 is disposed on the first passivation layer 180p. The color filter 230 is disposed in an entire region where the thin film transistors Qh, Ql and Qc are not disposed. While the color filter 230 is illustrated in the lower display substrate, the invention is not limited thereto. In an exemplary embodiment, the color filter 230 may be disposed in the upper display substrate 200 and/or may be disposed to vertically extend between the neighboring data lines 171 to overlap the thin film transistors Qh, Ql and Qc. Among a plurality of color filters, each color filter 230 may display one of three primary colors such as red, green and blue, but the invention is not limited thereto.

A light blocking member 220 may be disposed on a region where the color filter 230 is not disposed and may be extended to overlap the color filter 230. The light blocking member 200 may otherwise be referred to as a black matrix and reduces or effectively prevents light leakage. The light blocking member 220 has a length which extends along an extension direction of the gate line 121 and the step-down gate line 123. Among portions defined by the blocking member 220, a first light blocking member (not shown) may have a length horizontally extended to cover the region where the thin film transistors Qh, Ql and Qc are disposed and a second light blocking member (not shown) may have a length vertically extended to cover the data line 171. In a cross-sectional thickness direction, a height of the light blocking member 220 may be smaller than that of the color filter 230. The heights may be taken from a common reference such as an upper surface of the first insulation substrate 110.

A second passivation layer 180q is disposed on the color filter 230 and on the light blocking member 220. The second passivation layer 180q reduces or effectively prevents the color filter 230 and the light blocking member 220 from being lifted upward and away from underlying layers of the lower display substrate 100, and may suppress contamination of the liquid crystal layer 3 by an organic material such as a solvent from the color filter 230.

A first contact hole 185h and a second contact hole 185l are defined in the first passivation layer 180p, the light blocking member 220 and the second passivation layer 180q to respectively expose the wide first end portion of the first drain electrode 175h and the wide first end portion of the second drain electrode 175l.

A pixel electrode 191 is disposed on the second passivation layer 180q. The pixel electrode 191 may include or be made of a transparent conductive oxide such as indium tin oxide (“ITO”) or indium zinc oxide (“IZO”).

Referring to FIG. 1, within a pixel area of a pixel, the pixel electrode 191 includes the first and second subpixel electrodes 191h and 191l, which are separated from each other with the two gate lines 121 and 123 therebetween. The first and second subpixel electrodes 191h and 191l are respectively disposed at upper and lower portions of the pixel with respect to the two gate lines 121 and 123 and are adjacent to each other in the vertical (e.g., column) direction.

A slit 91a and 91b is defined in the pixel electrode 191 along the edge thereof. A first slit 91a is defined along an outer edge of the first subpixel electrode 191h. A second slit 91b is defined along an outer edge of the second subpixel electrode 191h. By forming the slit 91a and 91b to have lengths extended along the outer edge of the pixel electrode 191, a fringe field formed at the outer edge of the pixel can be controlled to control tilt directions of directors of liquid crystal molecules of the liquid crystal layer 3 disposed at the outer edges of the first and second subpixel electrodes 191h and 191l.

An insulating layer 80 is disposed on the pixel electrode 191 and an auxiliary electrode 192 is disposed on the insulating layer 80. The auxiliary electrode 192 includes a first auxiliary electrode 192a overlapping the first subpixel electrode 191h and a second auxiliary electrode 192b overlapping the second subpixel electrode 191l. Each of the auxiliary electrodes 192 may have a cross shape when viewed in the top plan view. End portions or edges of the first and second auxiliary electrodes 192a and 192b may protrude further than the outer edges of the first and second subpixel electrodes 191h and 191l which are overlapped by the first and second auxiliary electrodes 192a and 192b, respectively. The insulating layer 80 may include or be made of an inorganic or organic material. The auxiliary electrode 192 may include or be made of a transparent conductive oxide such as ITO or IZO, to include or be made of the same material as that of the pixel electrode 191.

The first and second subpixel electrodes 191h and 191l respectively receive a data voltage from the first and second drain electrodes 175h and 175l via contact therebetween at the first and second contact holes 185h and 185l. The first and second subpixel electrodes 191h and 191l, to which the data voltage is applied, generate an electric field in conjunction with a common electrode 270 of the upper display substrate 200 to determine directions of the liquid crystal molecules of the liquid crystal layer 3 between the two electrodes 191 and 270. Luminance of light passing through the liquid crystal layer 3 varies according to the determined directions of the liquid crystal molecules. The first auxiliary electrode 192a may receive the same voltage as the data voltage applied to the first subpixel electrode 191h and the second auxiliary electrode 192b may receive the same voltage as the data voltage applied to the second subpixel electrode 191l. For this purpose, the first auxiliary electrode 192a and the second auxiliary electrode 192b may be respectively electrically connected to the first and second subpixel electrodes 191h and 191l while interposing the insulating layer 80 therebetween.

The first subpixel electrode 191h and the common electrode 270 form a first liquid crystal capacitor in conjunction with the liquid crystal layer 3 therebetween, and the second subpixel electrode 191l and the common electrode 270 form a second liquid crystal capacitor in conjunction with the liquid crystal layer 3 therebetween, thereby maintaining the voltage applied to the subpixel and auxiliary electrodes even after the first and second thin film transistors Qh and Ql connected to the subpixel and auxiliary electrodes are turned off.

The first and second subpixel electrodes 191h and 191l overlap the storage electrode line 125 as well as the storage electrode 129 to form first and second storage capacitors, respectively. The first and second storage capacitors respectively enhance voltage sustaining capabilities of the first and second liquid crystal capacitors described above.

The capacitive electrode 126 and the expansion 177c of the third drain electrode 175c overlap each other to form the step-down capacitor Cstd while interposing the gate insulating layer 140, the semiconductor 157 and the ohmic contact 167 therebetween. In an exemplary embodiment, the semiconductor 157 and the ohmic contact 167 disposed between the capacitive electrode 126 and the expansion 177c included in the step-down capacitor Cstd may be omitted.

A supporting member 320 may be disposed on the insulating layer 80. Portions of the insulating layer 80 are exposed by the supporting member 320. The supporting member 320 is disposed on the light blocking member 220. The supporting member 320 has lengths which extend between the gate line 121 and the step-down gate line 123 adjacent to each other to cover the gate line 121 and the step-down gate line 123. Among portions defined by the supporting member 320, a first supporting member (not shown) may have a length extending horizontally along the first light blocking member covering the region where the thin film transistors Qh, Ql and Qc are disposed, and a second supporting member (not shown) may have a length extending vertically along the second light blocking member extending along the data line 171.

The supporting member 320 compensates a height difference between the light blocking member 220 and the color filter 230. The supporting member 320 also controls cell gaps of the liquid crystal layer disposed on the color filter 230 and of the liquid crystal layer disposed on the light blocking member 220 to be constant or the same as each other, enabling the light blocking member 220 to further reduce or effectively prevent light leakage. In a conventional LCD, the liquid crystal molecules disposed between the light blocking member 220 and the color filter 230 may not be correctly controlled owing to a step between the light blocking member 220 and the color filter 230. However, in the exemplary embodiment of the present invention, since the height difference between the light blocking member 220 and the color filter 230 is compensated by the supporting member 320, light leakage around the edge of the pixel electrode 191 due to improper control of the liquid crystal molecules around the edge of the pixel electrode 191 can be reduced or effectively prevented. In addition, since the cell gap above the smaller height light blocking member 220 is reduced by the supporting member 320 disposed at the light blocking member 220, an average cell gap of the LCD can be reduced and a total amount of liquid crystals used in the LCD can thus be reduced.

A lower alignment layer (not shown) is disposed on the auxiliary electrode 192, the exposed portions of the insulating layer 80 and the supporting member 320. The lower alignment layer may be a vertical alignment layer, and may include a photoactive material.

Next, the upper display substrate 200 will be described.

The common electrode 270 is disposed on a second insulation substrate 210 as a base substrate of the upper display substrate 200. An upper alignment layer (not shown) is disposed on the common electrode 270. The upper alignment layer may be a vertical alignment layer, and may be an alignment layer including a photoactive material. The common electrode 270 is disposed as a unitary plate, such as not having defined therein slits or patterns like those of the pixel electrode 191 described above.

Polarizers (not shown) are respectively provided on the outer surfaces of the two display substrates 100 and 200. Transmissive axes of the two polarizers are perpendicular to each other and one of the transmissive axes may be parallel to the gate line 121. In an exemplary embodiment a polarizer may be disposed on only one of the outer surfaces of the two display substrates 100 and 200.

The liquid crystal layer 3 includes liquid crystal molecules 31 that have negative dielectric anisotropy. The liquid crystal layer 3 may include a polymer. The liquid crystal molecules 31 may be aligned such that their long axes are substantially perpendicular to surfaces of the two display substrates 100 and 200 when no electric field is present. The liquid crystal molecules 31 may be initially arranged by the fringe field applied to the edges of the auxiliary electrodes 192a and 192b and the subpixel electrodes 191h and 191l to have pretilts. The pretilts may include long axes of the liquid crystal molecules 31 substantially parallel with respect to directions toward a center of the cross-shaped auxiliary electrodes 192a and 192b, the directions taken toward the center from four locations where the edges of the subpixel electrodes 191h and 191l that extend in different directions meet each other. Accordingly, each of first and second subpixels defined in the pixel has four domains among which the liquid crystals have different pretilt directions from each other.

As previously described, since the first and second subpixel electrodes 191h and 191l to which the data voltage is applied generate the electric field in conjunction with the common electrode 270 of the upper display substrate 200, the liquid crystal molecules of the liquid crystal layer 3 which are aligned to be perpendicular to the surfaces of the two electrodes 191 and 270 when no electric field is present, lie in a direction parallel to the surfaces of the two electrodes 191 and 270. Where the liquid crystal molecules of the liquid crystal layer 3 lie to be inclined in a direction parallel to the surfaces of the two electrodes 191 and 270, luminance of light passing through the liquid crystal layer 3 varies depending on the degree of the inclination of the liquid crystal molecules. When no electric field is present, even though the liquid crystal molecules of the liquid crystal layer 3 are aligned to be perpendicular to the surfaces of the two electrodes 191 and 270, incident light is blocked since the crossed polarizers do not allow the incident light to pass therethrough.

The LCD may further include a spacer 325 which maintains the cell gap between the two display substrates 100 and 200. The spacer 325 may be a separate element from the supporting member 320 or may be unitary therewith. In an exemplary embodiment of manufacturing the LCD the spacer 325 may be formed simultaneously with and in a same layer as the supporting member 320 among layers of the lower display substrate 100 disposed on the first insulation substrate 110. Portions of a collective supporting member may define a main portion 320 thereof and a spacer portion 325.

A driving method of the LCD illustrated in FIGS. 1 and 2 will now be described.

When a gate-on signal is applied to the gate line 121, first and second thin film transistors Qh and Ql connected thereto are turned on. Thus, a data voltage applied to a data line 171 is transmitted by the data line 171 to be applied to the first and second subpixel electrodes 191h and 191l via the turned-on first and second thin film transistors Qh and Ql. The data voltages applied to the first and second subpixel electrodes 191h and 191l are identical to each other. Accordingly, the voltages charged in first and second liquid crystal capacitors are identical. When a gate-off signal is applied to a gate line 121 and a gate-on signal is applied to a step-down gate line 123, the first and second thin film transistors Qh and Ql are turned off, while the third thin film transistor Qc is turned on. With the first and second thin film transistors Qh and Ql turned off while the third thin film transistor Qc is turned on, since charges migrate from the second subpixel electrode 191l to the step-down capacitor Cstd via the third thin film transistor Qc, the charged voltage of the second liquid crystal capacitor is decreased and the step-down capacitor Cstd is charged. Since the charged voltage of the second liquid crystal capacitor is decreased by capacitance of the step-down capacitor Cstd, the charged voltage of the second liquid crystal capacitor is lower than the charged voltage of the first liquid crystal capacitor.

The charged voltages of the two liquid crystal capacitors represent different gamma curves, and a gamma curve of a voltage of one pixel is obtained by combining the gamma curves. In the LCD, a front view combined gamma curve coincides with a front view reference gamma curve, while a side view combined gamma curve becomes closest to the front view reference gamma curve. Side visibility is improved by converting image data as such.

In addition to the method described above, various techniques for differently configuring charged voltages in the first and second liquid crystal capacitors can be applied to the invention. In an exemplary embodiment, for example, the third thin film transistor Qc may be designed to have a connection thereof between an output terminal of the second thin film transistor Ql and a reference voltage line to allow the charged voltage of the second liquid crystal capacitor Ql to be partially applied to the third thin film transistor Qc. As another example, the first and second liquid crystal capacitors may be connected to different data lines to receive different data voltages, thereby differentiating the charged voltage of the first liquid crystal capacitor from that of the second liquid crystal capacitor. In addition, using various other methods, the charged voltages of the first and second liquid crystal capacitors can be differently configured.

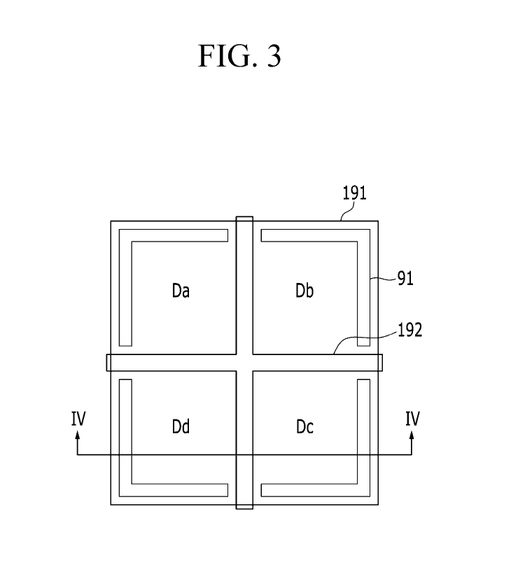

A basic region of a field generating electrode of the LCD according to the invention will now be described with reference to FIGS. 3 to 6.

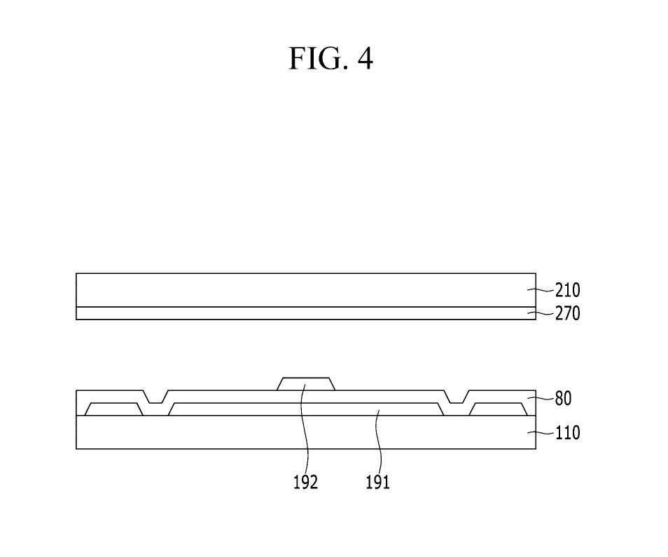

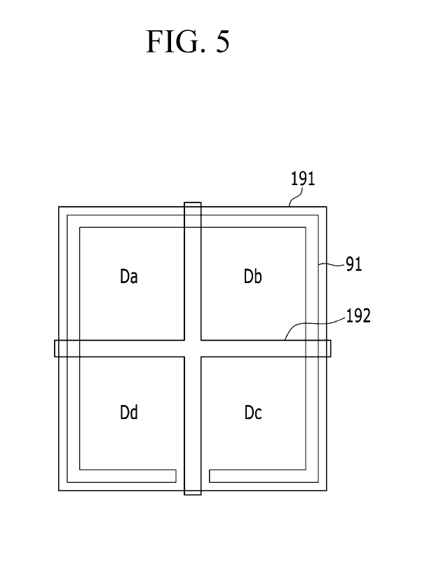

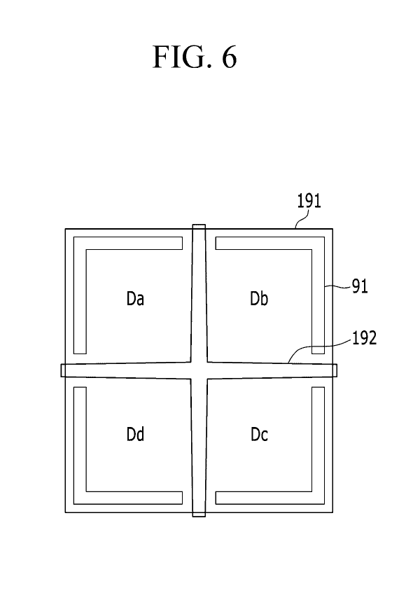

FIG. 3 is a top plan view of an exemplary embodiment of a basic region of a field generating electrode illustrated in FIG. 1, and FIG. 4 is a cross-sectional view of the field generating electrode of FIG. 3 taken along line IV-IV. FIGS. 5 and 6 are top plan views respectively showing other exemplary embodiments of basic regions of a field generating electrode according to the invention. While reference numerals 191, 192 and 91 are generally used in FIGS. 3-6 for convenience of explanation, the features disclosed in FIGS. 3-6 may be respectively applied to any of the first and second subpixel electrodes 191h and 191l, the first and second auxiliary electrodes 192a and 192b and the first and second slits 91a and 91b.

Referring to FIGS. 3 and 4, the basic region of the field generating electrode includes a pixel electrode 191, an auxiliary electrode 192 and a common electrode 270. The auxiliary electrode 192 is disposed on the pixel electrode 191 while interposing an insulating layer 80 therebetween. When viewed in the top plan view, the basic region defined by edges of the pixel electrode 191 and the auxiliary electrode 192 may be divided into four domains Da, Db, Dc and Dd, and the domains Da, Db, Dc, and Dd may be symmetrical to each other with respect to the auxiliary electrode 192.

When applying a data voltage to the pixel electrode 191 and the auxiliary electrode 192 and applying a common voltage to the common electrode 270, an electric field is generated between the two display substrates 100 and 200. The insulating layer 80 is disposed between the pixel electrode 191 and the auxiliary electrode 192, such that even if the same voltage is applied to these electrodes, an effective voltage of the pixel electrode 191 is different from an effective voltage of the auxiliary electrode 192 due to a voltage drop effect associated with a thickness of the insulating layer 80. Herein, the term “effective voltage” means voltage which acts to generate an electric field in the liquid crystal. The effective voltage of the auxiliary electrode 192 is higher than that of the pixel electrode 191 due to the voltage drop effect, so intensity of the fringe field by the auxiliary electrode 192 may become stronger as compared to that of the pixel electrode 191.

Accordingly, when the electric field is generated, due to the fringe field associated with the edges of the pixel electrode 191 and edges of the auxiliary electrode 192, the liquid crystal molecules of the liquid crystal layer within the basic region of the field generating electrode are tilted substantially parallel with respect to a direction toward a center portion of the cross-shaped auxiliary electrode 192. The direction toward the center portion of the cross-shaped auxiliary electrode 192 is taken from four corner portions of the basic region of the field generating electrode. The four corner portions of the basic region of the field generating electrode are defined where edges of the pixel electrode 191 that extend in different directions from each other meet. That is, in one basic region of the field generating electrode, the liquid crystal molecules have a total of four tilt directions, and tilt directions of the liquid crystal molecules are different in each of the domains Da, Db, Dc and Dd.

In some exemplary embodiments, a voltage level different from the data voltage applied to the pixel electrode 191 may be applied to the auxiliary electrode 192, and, for example, a voltage higher than the data voltage may be applied thereto. However, when voltages of different levels are applied to the pixel electrode 191, the auxiliary electrode 192 may have a more complex circuit as compared to the exemplary embodiment of the invention described above in which the insulating layer 80 and the voltage drop effect are utilized.

In the exemplary embodiment of the invention, since the fringe field generated by the edges of the pixel electrode 191 and the auxiliary electrode 192 is used to create the domains where the liquid crystal molecules are tilted in different directions, transmittance of the LCD can be increased as compared to a conventional LCD for which a plurality of minute slits are defined in the pixel electrode of the LCD. In addition, compared to where the slits are not formed in the pixel electrode, but are formed in the common electrode, display quality degradation, such as transmittance deterioration associated with the slits of the common electrode and misalignment of the pixel electrode, does not occur. In addition, a mask and a process for forming the slits in the common electrode are not required.

The auxiliary electrode 192 has a cross shape when viewed in the top plan view. Distal end portions of the auxiliary electrode 192 may protrude further than the edges of the pixel electrode 191. Where the distal end portions of the auxiliary electrode 192 may protrude further than the edges of the pixel electrode 191, since intensity of the fringe field by the auxiliary electrode 192 may become stronger as compared to that of the pixel electrode 191, arrangement of the liquid crystal molecules can be more stably controlled at the edges of the pixel in desired directions, and thereby texture generation can be suppressed.

Portions of the auxiliary electrode 192 forming the cross shape have lengths extending in the horizontal and vertical directions in the top plan view, to define extension directions of such portions. Respective widths of the portions of the auxiliary electrode 192 are taken perpendicular to the extension directions thereof. A width of the auxiliary electrode 192 may be less than three times the thickness of the liquid crystal layer 3, e.g., the cell gap.

Referring to FIG. 3, a slit 91 is defined at the outer edges of the pixel electrode 191. The slit 91 is defined to have an overall substantially quadrangular ring shape within the basic region of the field generating electrode. The slit 91 is disconnected proximate to portions corresponding to the auxiliary electrode 192, and is thus divided into four portions which do not overlap the auxiliary electrode 192. As such, portions of the pixel electrode 191 between disconnected portions of the slit 91 become connecting portions of the pixel electrode 191. A width of the connecting portion of the pixel electrode 191 is wider than that of the corresponding auxiliary electrode 192.

The slit 91 of the pixel electrode 191 may control tilt directions of directors of the liquid crystal molecules disposed at the outer edges of the pixel electrode 191 by controlling the fringe field that influences the edges of the pixel. The slit 91 of the pixel electrode 191 may be disposed to be separated from the outer edges of the pixel electrode 191 at an interval less than two times the cell gap. Portions of slit 91 have lengths extending in the horizontal and vertical directions in the top plan view, to define extension directions of such portions. Respective widths of the portions of the slit 91 are taken perpendicular to the extension directions thereof. The width of the slit 91 may be less than about two times the cell gap.

Referring to FIG. 5, the slit 91 of the overall quadrangular ring shape is disposed at the edges of the pixel electrode 191. However, unlike in the exemplary embodiment of FIG. 3, the slit 91 is continuous while being disconnected in only one portion corresponding to the auxiliary electrode 192. Accordingly, the slit 91 partially overlaps the auxiliary electrode 192. The portion in the pixel electrode 191 at which the slit 91 is disconnected becomes the connecting portion of the pixel electrode 191.

Referring to FIG. 6, unlike in the exemplary embodiment of FIG. 3 where a width of the cross-shaped auxiliary electrode 192 is substantially uniform, the auxiliary electrode 192 is disposed such that a width thereof gradually decreases closer to a distal end portion thereof. Where the width of the auxiliary electrode 192 gradually decreases closer to a distal end portion thereof as compared to where the width of the auxiliary electrode 192 is uniform, texture suppression control can be enhanced because liquid crystal control is improved. In some exemplary embodiments, a portion of the width of the auxiliary electrode 192 may be uniform such as a portion disposed closer to the distal end portion thereof, and then decrease. In some exemplary embodiments, the width of the auxiliary electrode 192 may initially gradually decrease to be constant at the distal end portion thereof.

One basic region of the field generating electrode described above is disposed to correspond to the overall first subpixel electrode 191h, as shown in FIG. 1, while two basic regions may be disposed to correspond to the overall second subpixel electrode 191l. In this arrangement, a total of eight domains may be formed to correspond to the second subpixel electrode 191l. However, the arrangement of the basic regions within a pixel is not limited thereto. In an exemplary embodiment, only basic region may be disposed to correspond to each of the first and second subpixel electrodes 191h and 191l within a pixel, or multiple basic regions may be disposed to correspond to each of the first and second subpixel electrodes 191h and 191l within a pixel.

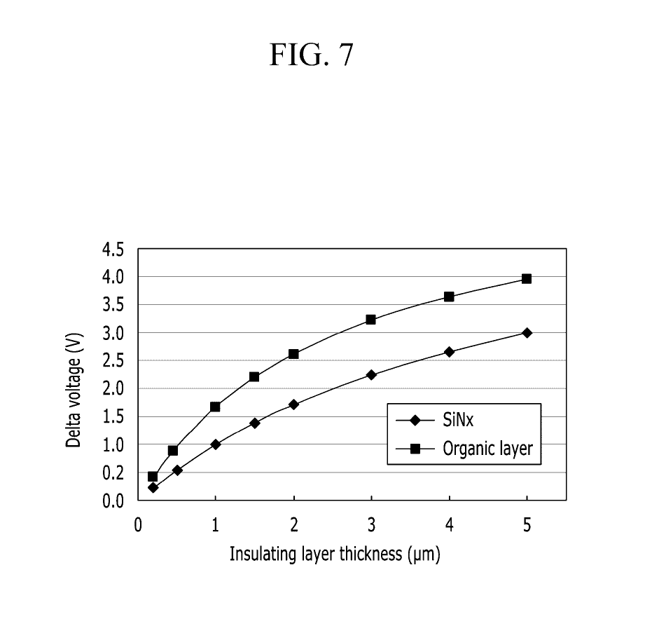

A relationship between effective voltages related to the insulating layer 80, the pixel electrode 191 and the auxiliary electrode 192 will now be described with reference to FIG. 7.

FIG. 7 is a graph showing how an effective voltage of the pixel electrode 191 and the auxiliary electrode 192 varies according to the thickness and material of the insulating layer 80 disposed therebetween.

The effective voltage applied to the liquid crystal layer is dependent upon a dielectric constant and a cross-sectional thickness of the insulating layer 80, as shown in the following equation.

V_{LC}=V_{A}[1+{(d_{P}/d_{LC})/(∈_{P}/∈_{LC})}]⁻¹

In this case, V_{LC} is an effective voltage, V_{A} is an applied voltage, d_{P} is a cross-sectional thickness of the insulating layer, d_{LC} is a cell gap taken in the thickness direction, ∈_{P} is a dielectric constant of the insulating layer, and ∈_{LC} is a dielectric constant of the liquid crystal.

Accordingly, as shown in FIG. 7, a difference (Delta voltage) in volts (V) between the effective voltages of the pixel electrode 191 and the auxiliary electrode 192 is proportionate to the thickness in micrometers (μm) of the insulating layer 80. The difference between the effective voltages is greater when the insulating layer 80 includes or is made of an organic layer compared to when the insulating layer 80 includes or is made of an inorganic layer such as silicon nitride (SiNx). The insulating layer 80 may be disposed to define an effective voltage ratio of the pixel electrode 191 to the auxiliary electrode 192 of about 0.85 to about 0.9, but is not limited thereto. Considering a level of processing difficulty and the effective voltage ratio (e.g., approximately 0.9) of the effective voltage of the pixel electrode 191 to that of the auxiliary electrode 192, the insulating layer 80 may include or be made of silicon nitride having a thickness of about 3,000 angstroms (Å) to about 5,000 Å, for example, a thickness of about 4,000 Å.

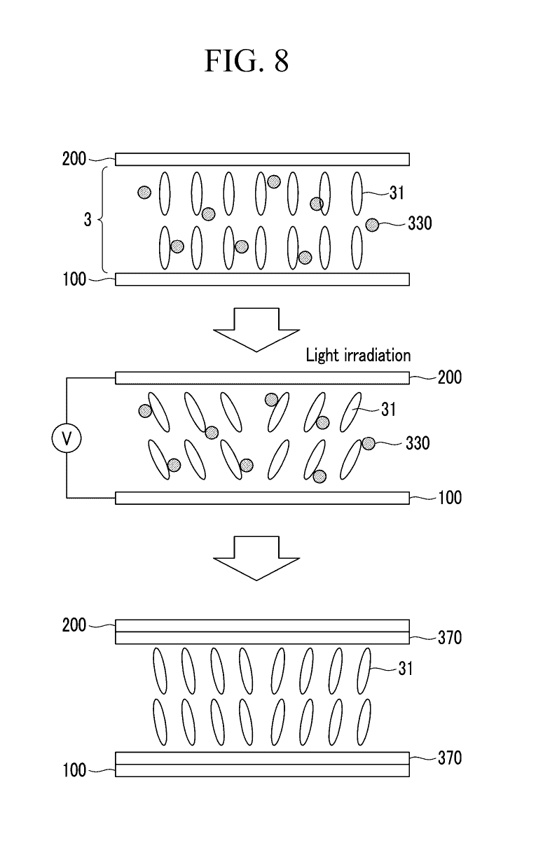

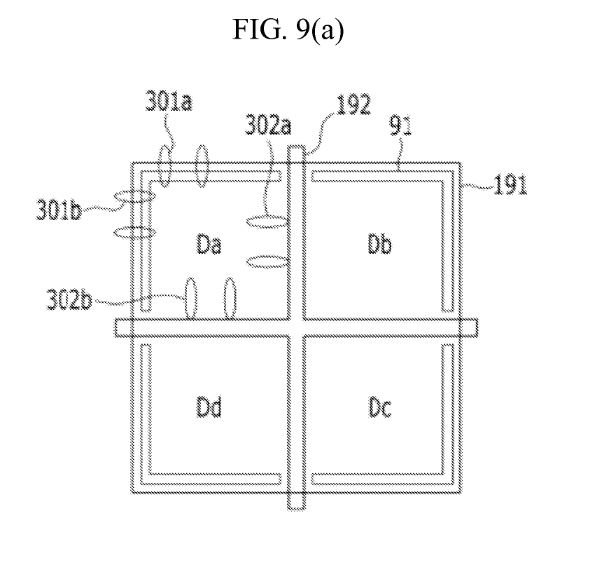

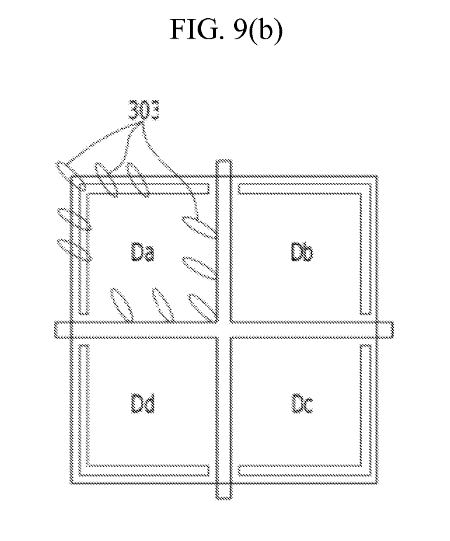

A method for initially aligning liquid crystal molecules to have pretilts will be now described with reference to FIGS. 8 and 9.

FIG. 8 illustrates an exemplary embodiment of a process in which liquid crystal molecules are changed from an untilted state to have pretilts, and FIG. 9 (a) and FIG. 9(b) schematically illustrate directions of liquid crystals in the basic region of the field generating electrode according to the invention.

First, referring to the top view of FIG. 8 and FIG. 9(a), a monomer 330 such as reactive mesogen which is curable by polymerization is injected between two display substrates 100 and 200, along with a liquid crystal material. The monomer 330 may be included in both a liquid crystal layer and in an alignment layer (not shown) that is disposed between two display substrates 100 and 200, but the invention is not limited thereto.

Next, referring to the middle view of FIG. 8 and FIG. 9(b), a data voltage (V) is applied to first and second subpixel electrodes 191h and 191l and to first and second auxiliary electrodes 192a and 192b of the lower display substrate 100, and a common voltage is applied to the common electrode 270 of the upper display substrate 200, thereby generating an electric field between the two display substrates 100 and 200. Under influence of the electric field between the two display substrates 100 and 200, the liquid crystal molecules 31 of the liquid crystal layer 3 are changed from an untilted state to be tilted in different directions in four domains by a fringe field that is generated by edges of the pixel electrode 191 and the auxiliary electrode 192.

Specifically, referring to FIG. 9(a), outer edge directors 301a and 301b of liquid crystal molecules 31 around the outer edges of the pixel electrode 191 which define the basic region of the field generating electrode are perpendicular with respect to the outer edges of the pixel electrode 191. In addition, inner are directors 302a and 302b of the liquid crystal molecules 31 around the auxiliary electrode 192 at an inner area of the pixel electrode 191 are perpendicular with respect to edges of the auxiliary electrode 192. As such, the directors of the liquid crystal molecules 31 are initially arranged by a fringe field that is generated by the edges of the pixel electrode 191 defining the basic region of the field generating electrode and the auxiliary electrode 192 (the top view of FIG. 8 and FIG. 9(a)), and are then rearranged in directions such that the liquid crystal molecules are minimally deformed when they meet each other, such that a secondary alignment direction may be a direction of a vector sum of directions of the respective directors. Accordingly, the directors 303 of the liquid crystal molecules 31 are, as illustrated in FIG. 9(b), nearly parallel with respect to a direction extending toward a center portion of the cross-shaped auxiliary electrode 192 from four portions (e.g., corners of the basic region of the field generating electrode) where the edges of the pixel electrode 191 that extend in different directions from each other meet.

Although the directors of the liquid crystal molecules 31 are shown for domain Da in FIG. 9(a) and FIG. 9(b), the directors of the liquid crystal molecules 31 are similarly arranged by the fringe field in each of the domains Da, Db, Dc and Dd, and the liquid crystal molecules have a total of four tilt directions within each of the basic regions of the field generating electrodes. Specifically, referring to FIG. 9(b), the directors 303 of the liquid crystal molecules 31 in the first domain Da are obliquely arranged to be extended toward a lower right direction such that they are directed toward the center portion of the auxiliary electrode 192 from the edges of the pixel, the directors of the liquid crystal molecules 31 in the second domain Db are obliquely arranged to be extended toward a lower left direction such that they are directed toward the center portion of the auxiliary electrode 192 from the edges of the pixel, the directors of the liquid crystal molecules 31 in the third domain Dc are obliquely arranged to be extended toward an upper left direction such that they are directed toward the center portion of the auxiliary electrode 192 from the edges of the pixel, and the directors of the liquid crystal molecules 31 in the fourth domain Dd are obliquely arranged to be extended toward an upper right direction such that they are directed toward the center portion of the auxiliary electrode 192 from the edges of the pixel.

Referring again to the middle view of FIG. 8, when light such as ultraviolet rays is irradiated after generating the electric field in the liquid crystal layer 3, the monomer 330 migrates toward the display substrates 100 and 200 and forms a polymer 370. When the monomer 330 is included in the alignment layer, the polymer may be disposed in the alignment layer. Alignment directions are determined such that the liquid crystal molecules 31 have pretilts in the previously described directions by the polymer 370. Accordingly, referring to the bottom view of FIG. 8, when no voltage is applied to the field generating electrodes 191 and 270, the liquid crystal molecules 31 are arranged such that they have the pretilts in the four different directions as shown in FIG. 9(b).

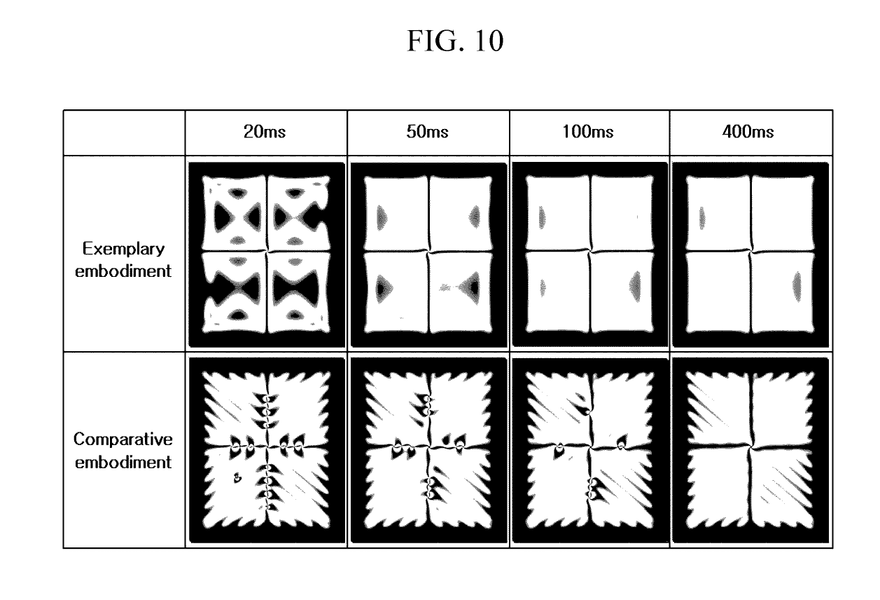

Some experimental examples of the invention will now be described with reference to FIGS. 10 to 12.

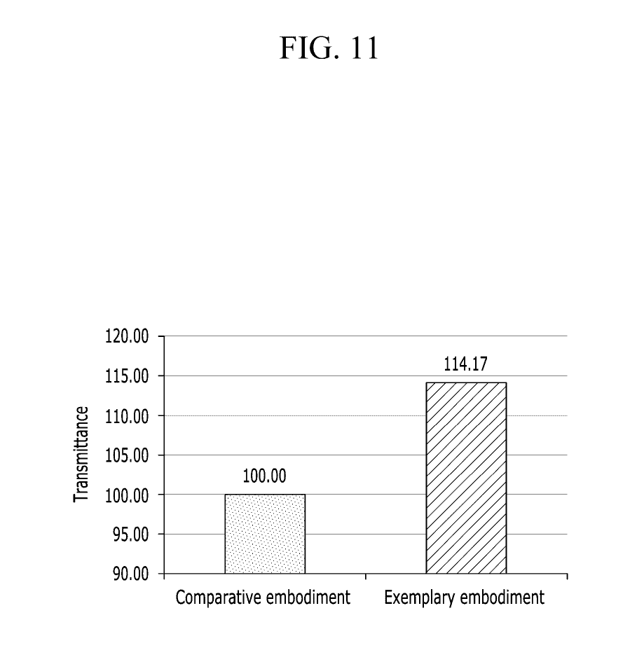

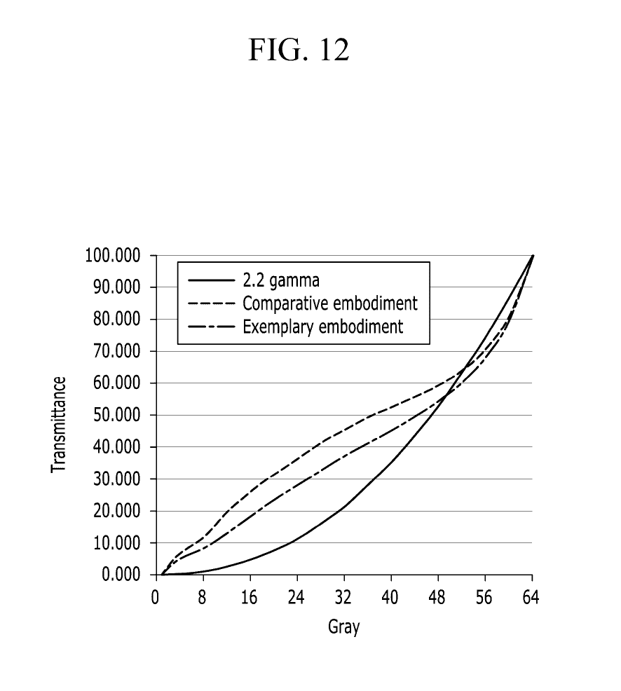

FIG. 10 includes views of simulation results showing texture control in an exemplary embodiment of the LCD according to the invention and texture control in a comparative embodiment of an LCD. FIG. 11 is a graph showing transmittance of the exemplary embodiment of the LCD according to the invention and transmittance of the comparative embodiment of the LCD. FIG. 12 is a graph showing variation of transmittance the exemplary embodiment of the LCD according to the invention and that of the comparative embodiment of the LCD with respect to gray.

Referring to FIGS. 10 and 12, the exemplary embodiment LCD includes the basic region of the field generating electrode of the pixel is formed as described with reference to FIGS. 1 and 4, while the comparative embodiment LCD includes a plurality of minute slits defined in the pixel electrode which represents the basic region of the field generating electrode of the pixel. In the exemplary embodiment LCD, the insulating layer 80 includes or is made of a silicon nitride having a thickness in A, and a ratio of the effective voltage of the pixel electrode 191 to that of the auxiliary electrode 192 is set to 0.9. A size of the pixel is simulated based on a pixel of a 55-inch ultra-high definition (“UHD”).

FIG. 10 illustrates when liquid crystals are controlled in a state thereof prior to forming the pretilts. According to the comparative embodiment LCD, texture is generated when a white data voltage is applied for 100 milliseconds (ms), and texture is not generated when white data voltage is applied for 400 ms. In contrast, according to the exemplary embodiment LCD of the invention, texture is not generated when the white data voltage is applied for about 100 ms, which achieves the same state as the comparative embodiment LCD at the later time of 400 ms. This means that an initial alignment processing time for forming the pretilts of the LCD according to one or more exemplary embodiment of the invention can be considerably reduced compared to the comparative embodiment LCD, and as a result manufacturing costs can be reduced.

Referring to FIG. 11, when transmittance of the pixel according to the comparative embodiment LCD is 100, transmittance of the pixel according to the exemplary embodiment LCD of the invention corresponds to 114.17. Accordingly, the transmittance of the LCD according to one or more exemplary embodiment of the invention is improved by about 14% over that of the comparative embodiment LCD.

Referring to FIG. 12, a gray-transmittance curve associated with side visibility of the LCD is illustrated. A solid line represents transmittance variations according to gray (based on 2.2 gamma) when viewed from the front of the LCD, an alternated long and short dash line represents transmittance variations according to gray when the LCD according to the exemplary embodiment of the invention is viewed from 60 degrees to the right side thereof, and a dotted line represents transmittance variations according to gray when the LCD according to the comparative embodiment is viewed from 60 degrees to the right side thereof. In general, as the side view gray-transmittance curve of an LCD becomes closer to the gray-transmittance curve at the front (based on 2.2 gamma), the side visibility is improved and thus more accurate gray expression is possible. Referring to FIG. 12, the side view gray-transmittance curve of the exemplary embodiment LCD according to the invention is closer to the gray-transmittance curve at the front (based on 2.2 gamma) than the side view gray-transmittance curve of the comparative embodiment LCD and a gamma distortion index has improved by about 0.07.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A liquid crystal display comprising:
a lower display substrate comprising:
a pixel electrode disposed on a first base substrate; and
a cross-shaped auxiliary electrode disposed overlapping the pixel electrode on the first base substrate;
an upper display substrate facing the lower display substrate, the upper display substrate comprising a common electrode disposed on a second base substrate; and
a liquid crystal layer disposed between the lower display substrate and the upper display substrate, the liquid crystal layer including liquid crystal molecules.

2. The liquid crystal display of claim 1, wherein the lower display substrate further comprises:
an insulating layer disposed between the cross-shaped auxiliary electrode disposed overlapping the pixel electrode and the pixel electrode which is overlapped thereby.

3. The liquid crystal display of claim 2, wherein:
the pixel electrode and the auxiliary electrode between which is disposed the insulating layer receive a same voltage.

4. The liquid crystal display of claim 2, wherein:
the insulating layer disposed between the pixel electrode and the auxiliary electrode comprises silicon nitride, and
a cross-sectional thickness of the insulating layer comprising silicon nitride disposed between the pixel electrode and the auxiliary electrode is about 3,000 Å to about 5,000 Å.

5. The liquid crystal display of claim 1, wherein among the cross-shaped auxiliary electrode disposed overlapping the pixel electrode and the pixel electrode which is overlapped thereby:
a slit is defined in the pixel electrode at outer edges of the pixel electrode.

6. The liquid crystal display of claim 5, wherein in a top plan view:
pretilt directions of each of the liquid crystal molecules are arranged extended toward a center portion of the auxiliary electrode from respective points where the outer edges of the pixel electrode meet each other.

7. The liquid crystal display of claim 6, wherein:
the pixel electrode is divided into a plurality of domains by the outer edges of the pixel electrode and the auxiliary electrode which overlaps the pixel electrode, and
among the plurality of domains, the pretilt directions of the liquid crystal molecules are different from each other.

8. The liquid crystal display of claim 5, wherein:
in a state where no electric field is applied to the liquid crystal layer, long axes of the liquid crystal molecules are substantially perpendicular to surfaces of the first and second display substrates.

9. The liquid crystal display of claim 5, wherein in a top plan view:
the auxiliary electrode does not overlap the slit defined in the pixel electrode at the outer edges of the pixel electrode.

10. The liquid crystal display of claim 5, wherein in a top plan view:
the auxiliary electrode overlaps the slit defined in the pixel electrode at the outer edges of the pixel electrode.

11. The liquid crystal display of claim 5, wherein:
a width of the auxiliary electrode at a distal end thereof is smaller than that at a center thereof.

12. The liquid crystal display of claim 1, wherein:
the common electrode has a plate shape.

13. The liquid crystal display of claim 1, wherein among the cross-shaped auxiliary electrode disposed overlapping the pixel electrode and the pixel electrode which is overlapped thereby:
a ratio of an effective voltage of the pixel electrode to that of the auxiliary electrode is between about 0.85 and about 0.9.

14. The liquid crystal display of claim 2, wherein:
the pixel electrode and the auxiliary electrode within the first display substrate and between which the insulating layer is disposed are electrically connected to each other.

15. The liquid crystal display of claim 2, wherein:
the pixel electrode and the auxiliary electrode within the first display substrate and between which the insulating layer is disposed receive different voltages from each other.

16. The liquid crystal display of claim 5, wherein among the cross-shaped auxiliary electrode disposed overlapping the pixel electrode and the pixel electrode which is overlapped thereby:
the first display substrate further includes an insulating layer disposed between the pixel electrode and the auxiliary electrode, and
distal ends of the cross-shape auxiliary electrode extend further than the outer edges of the pixel electrode.
